(19) United States
(12) Patent Application Publication
(10) Pub. No.: US 2023/0067589 A1
(43) Pub. Date: Mar. 2, 2023

(54) RESIN COMPOSITION HAVING STRONG ADHESION TO A DIELECTRIC LAYER

(71) Applicant: Apple Inc., Cupertino, CA (US)

(72) Inventors: Shigeto Kobori, Tokyo-to (JP); Avery P. Yuen, San Jose, CA (US); Khadijeh Bayat, Santa Clara, CA (US); Masato Kuwabara, Tsukuba-Shi (JP); Nikhil D. Kalyankar, Fremont, CA (US)

(21) Appl. No.: 17/660,373

(22) Filed: Apr. 22, 2022

Related U.S. Application Data
(60) Provisional application No. 63/260,347, filed on Aug. 17, 2021.

(51) Int. Cl. C09D 183/04; C09D 7/61; G02B 1/14; H04M 1/02

(52) U.S. Cl. CPC C09D 183/04; C09D 7/61; G02B 1/14; H04M 1/026

(57) ABSTRACT

An optical device includes a dielectric substrate and a cured resin coating adhered to the substrate. The resin coating includes an organic component and an inorganic component. A surface portion of the resin coating includes greater than about 60 at. % inorganic component and less than about 40 at. % organic component, an intermediate portion includes between about 10 at. % and about 60 at. % inorganic component, and between about 40 at. % and about 90 at. % inorganic component, and a bottom portion includes less than about 10 at. % inorganic component and greater than about 90 at. % organic component. The resin coating has improved hard coat properties and excellent adhesion to a dielectric.

### CROSS-REFERENCE TO RELATED APPLICATION

This application claims the benefit of U.S. Provisional Patent Application No. 63/260,347, filed 17 Aug. 2021, and entitled “RESIN COMPOSITION HAVING STRONG ADHESION TO A DIELECTRIC LAYER,” the disclosure of which is incorporated herein by reference in its entirety.

### FIELD

The described embodiments relate generally to an optical device with a resin coating. More particularly, the present embodiments relate to a hard coat film with a resin composition having an adhesion to a dielectric substrate.

### BACKGROUND

Advances in display technology have resulted in the capabilities of portable display devices becoming more diversified. Portable display devices can include housings and screens with enhanced drop performance, larger screens, and cameras with multiple lenses and capabilities. To provide more diverse functions to users, these display devices can recognize a user's touch on a display panel and process an input based on the recognized touch. Demands for improved display devices continue to grow. As the display devices have become more functional, the range of uses has expanded and an increased durability is desired. As users rely more and more on these devices, the robustness of the devices also increases. Specifically, the screens and/or optical surfaces are designed to be more durable without sacrificing the functionality or quality of the device.

These portable display devices can include a hard coat layer to protect the display from scratches or external impacts. Various materials, such as tempered glass, have traditionally been used as the hard coat layer. Tempered glass is typically thinner than ordinary glass and has high strength and scratch resistance. However, the heavy weight of tempered glass may not be suitable for reducing the weight of portable devices. Furthermore, increased durability characteristics continue to be desired. Similarly, glass, polymer coatings, and other previously used materials can lack the desired adhesion or response to touch.

### SUMMARY

An optical device can include a dielectric substrate and a cured resin coating adhered to the substrate. The resin coating can include an organic component and an inorganic component. In some embodiments, a surface portion of the cured resin coating can include greater than to about 60 atomic percent (at. %) inorganic component and less than about 40 at. % organic component. An intermediate portion of the cured resin coating can include between about 5 at. % and about 65 at. % inorganic component and between about 35 at. % and about 95 at. % inorganic component, and a bottom portion of the cured resin coating can include less than or equal to about 15 at. % inorganic component and greater than or equal to about 90 at. % organic component.

In some embodiments, the resin coating can include a thickness between about 1 μm and about 50 μm. The inorganic component can include at least one material having a Zeta potential from about +1 mV to about +8 mV.

In some embodiments, the optical device can further include at least one inorganic layer disposed on the resin coating. The inorganic layer can include at least one of silicon oxide, silicon nitride, aluminum, aluminum oxide, niobium oxide, titanium oxide, zirconium oxide, hafnium oxide, tantalum oxide, magnesium fluoride, silver, gold, copper, and combinations thereof. The optical device can further include an anti-smudge layer. The anti-smudge layer can include a fluorinated hydrocarbon.

The resin coating can include a refractive index from about 1.25 to about 3.5. In some embodiments, the resin coating can include a surface structure having at least one of a refractive optical element, a reflective optical element, a diffractive optical element, an anti-glare surface, or a micro lens. The resin coating can be cured by applying the resin coating to the dielectric substrate and exposing the resin coating to UV irradiation. In some embodiments, the substrate can be selected from the group of a triacetylcellulose film, a lens, a 3D shaped resin component, and combinations thereof.

A resin coating can include a hydrophilic adhesion layer, a hardness control layer, and a hydrophobic surface layer. In some embodiments, the resin coating can include a viscosity of 3000 cps or less (3 kg m⁻¹ s⁻¹) before curing. The hydrophobic surface layer can include nanoparticles having a Zeta potential from about +1 mV to about +8 mV.

A resin composition can include a monomer having a first photo-polymerizable functional group, a first siloxane oligomer having a second photo-polymerizable functional group and a first dehydration-condensable functional group, a second siloxane oligomer having a second dehydration-condensable functional group, a metal oxide having a third photo-polymerizable functional group and a third dehydration-condensable functional group, and a photoinitiator.

The resin coating can include about 20 to about 40 parts by weight of the monomer, about 10 to about 20 parts by weight of the first siloxane oligomer, about 10 to about 20 parts by weight of the second siloxane oligomer, and about 10 to about 50 parts by weight of the metal oxide.

In some embodiments, the monomer includes a molecular weight of about 205 or less, the first siloxane oligomer includes a molecular weight of about 1000 or less, and the second siloxane oligomer includes a molecular weight between about 1000 and about 20,000.

In some embodiments, the first, second, and third photo-polymerizable functional group can be selected from the group of acrylate, methacrylate, glycidyl, and thiol. The first, second, and third dehydration condensable group can be selected from the group of alkoxy cyanate, hydroxyl cyanate, and isocyanate. The metal oxide can be selected from the group of zirconium oxide, silicon oxide, aluminum oxide, titanium oxide, cryolite (Na₃AlF₆), and magnesium fluoride. The photo initiator can include a photo-radical generator, and a photo-acid generator or a photo-base generator.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an isometric view of a portable electronic device including an optical device, according to an embodiment.

FIG. 2 shows an exploded view of various components of the portable electronic device of FIG. 1, according to an embodiment.

FIG. 3 shows a schematic cross-section of an optical device including a substrate and a resin coating, according to an embodiment.

FIG. 4 shows a schematic cross-section of a resin coating, according to an embodiment.

FIG. 5 shows a schematic cross-section of a substrate, a resin coating, and an inorganic layer, according to an embodiment.

FIG. 6A shows a schematic cross-section of a substrate, a resin coating, and an anti-smudge layer, according to an embodiment.

FIG. 6B shows a schematic cross-section of a substrate, a resin coating, an inorganic layer, and an anti-smudge layer, according to an embodiment.

FIG. 7A shows a flow chart of a method to prepare an optical device including a dielectric substrate and a cured resin coating, according to an embodiment.

FIG. 7B shows a flow chart of a method to prepare an optical device including a dielectric substrate and a cured resin coating, according to an embodiment.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments, as defined by the appended claims.

The following disclosure relates to an optical device including a substrate and a cured resin coating adhered to the substrate which can form a hard coating layer. Optical devices can be included on various surfaces of a portable electronic device. The optical device can include various layers or substrates, depending on the use of the optical device. There are many challenges associated with successfully integrating an optical system into a product. Small deviations from the intended optical design shape can affect the performance of the optic. These include, spacing, decenter, and tilt. As elements shift out of alignment in optical systems, image quality can progressively decay.

In addition, optical devices need to operate in a wide variety of ambient environments. While some products sit on desks and remain between 20 and 25° C. for their entire useful lives, many portable electronic devices or products can see temperatures from −40° C. to +60° C. (−40° F. to 140° F.) in various uses. Changes in temperature cause materials to expand and contract, which can destroy optical devices. Thermal expansion can cause changes in optical distances. Thermal expansion of a housing can shift the lens spacing. It can also change the focal lengths of lenses as the lens glass expands or contracts. This can cause an optic to lose focus when it changes temperature. More importantly, however, is the damage that optical systems can incur through thermal expansion. Commonly used metal housings and optical glasses are rigid materials. Due to this rigidity, stresses generated by a small change in component dimensions can be very high. These high stresses can lead to failures of the lens or housing.

Further, optical performance is rapidly degraded by condensation, dirt, and dust. Dust and dirt reduce the clarity of the optic, while condensation can blind the optic completely. Thus, optics pose unique and complex challenges. The challenges include managing thermal expansion of different materials, abrasion, maintaining the position of the optical devices for focus, and minimizing condensation and contaminates. The optical device should be durable and flexible, since portable electronic devices can be subject to drops, scratches, and impacts. The surfaces of the portable electronic device should maintain clarity and can need to be responsive to the touch of a user. An optical device that includes a dielectric substrate and a cured resin coating adhered to the substrate that can address these challenges is described in more detail below.

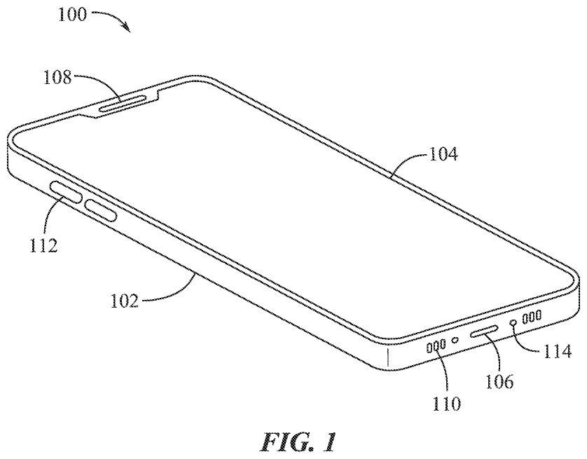

In a particular embodiment, the optical device can include any electronic device display assembly including, but in no way limited to an LCD, an LED, an OLED, a micro LED, a camera lens, a sensor, a monitor screen, a virtual reality component, etc. These and other embodiments can be included as optical devices and are discussed below with reference to FIGS. 1-7B. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a portable electronic device 100, in accordance with some embodiments. The portable electronic device 100 is a mobile electronic device, such as a smartphone. The smartphone of FIG. 1 is merely one representative example of a device that can be used in conjunction with the systems and methods disclosed herein. Electronic device 100 can correspond to any form of a wearable electronic device, a portable media player, a media storage device, a portable digital assistant, a tablet computer, a computer, a mobile communication device, a GPS unit, a remote control device, or another electronic device. The electronic device 100 can include a housing 102, a display assembly 104, a connector port 106, a speaker 108, various openings 110, and interface elements 112. The housing 102 can include a substrate having a cavity formed therein. The housing 102 can be formed of metal, plastic, ceramic, or any combination thereof. The housing 102 can be machined, forged, molded, extruded, or otherwise formed by a combination of techniques. In some embodiments, the housing 102 can be machined from an aluminum billet and can include a number of structures formed therein. A main structure is an opening in a surface of the aluminum billet that leads to a cavity. Operational components of the portable electronic device 100 can be disposed within the cavity.

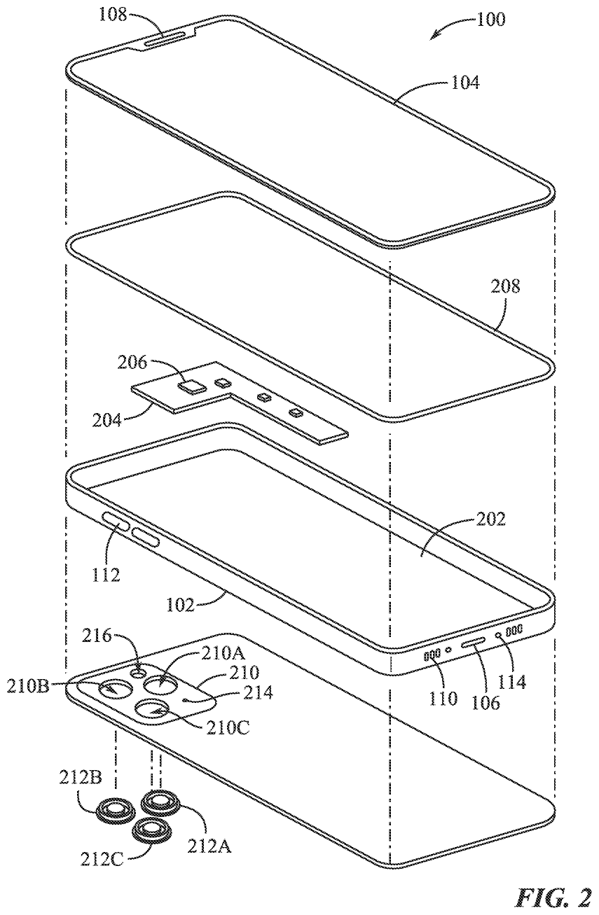

The display assembly 104 can be secured to the housing 102, at least in part, by one or more mechanical fasteners 114 disposed through an opening in the side of the housing 102. In some embodiments, the mechanical fasteners 114 can be omitted and the display assembly 104 is secured to the housing entirely by adhesive or hidden fasteners that are not visible on an external surface of the housing. In some embodiments, the connector port 106 is an opening in a surface of the housing 102 that accepts a male connector attached to a cable having a number of conductors. A female connector can be disposed in the connector port, enabling power and/or data signals to be provided to components disposed within the housing 102. In some embodiments, the display assembly 104 can include an optical device such as a liquid crystal display (LCD) layer disposed over a backlight. Alternatively, the display unit can be an organic light emitting diode (OLED) display that does not include a backlight. The display assembly 104 can also include one or more touch sensors for detecting touch input on a surface of the display assembly 104. In some embodiments, the display assembly 104 can include a dielectric substrate and a cured resin coating that can be adhered to a top surface of the display assembly 104. Additional details of the exemplary portable electronic device 100 are provided below with reference to FIG. 2.

FIG. 2 illustrates an exploded view of various components of the portable electronic device 100 of FIG. 1, according to an embodiment. The exploded view depicts operational components 206 disposed on a printed circuit board 204. The printed circuit board 204 is enclosed within a cavity 202 formed in the housing 102. The cavity 202 can be sealed using an adhesive 208 that surrounds a perimeter of an edge of the cavity 202. The adhesive 208 forms a bond between one or more surfaces of the housing 102 and corresponding surface(s) of the display assembly 104.

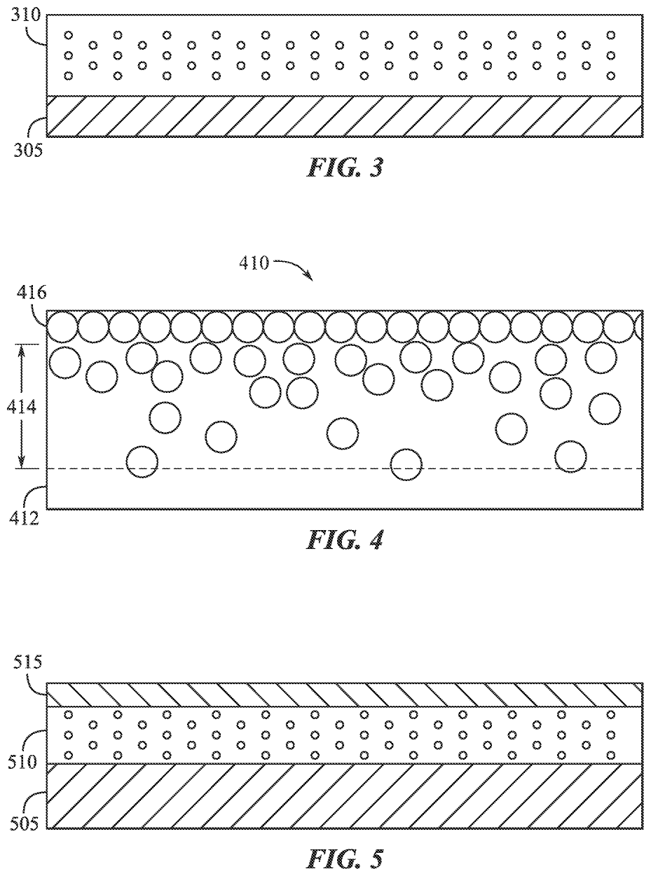

The operational components 206 can include various integrated circuit packages as well as electrical components soldered to the printed circuit board 204. In some embodiments, the operational components 206 can include a processor, memory, microelectromechanical systems (MEMS) devices, a system-on-chip (SoC), capacitors, resistors, inductors, and the like. Although not shown explicitly, the portable electronic device 100 can also include an energy storage device, such as a lithium-ion battery, as well as additional components such as haptic feedback systems. According to some embodiments, the portable electronic device 100 can include a camera assembly 210 that is carried at a corner portion of the portable electronic device 100. As illustrated in FIG. 2, the camera assembly 210 includes openings 210-A, B, C. Disposed within the camera openings 210-A, B, C are a first camera module, a second camera module, and a third camera module (not illustrated). Each of the openings 210-A, B, C can include a lens element 212-A, B, C coupled to the cameral modules. The lens elements 212-A, B, C can include a substrate and a cured resin coating adhered to the substrate. The camera assembly can also include openings 214 and 216 for a microphone and a strobe module (not illustrated). The display assembly 104, the camera assembly 210 and/or other components of the electronic device 100 may be protected and/or improved by a cured resin coating applied to one or more of the optical surfaces. Details regarding a cured resin coating that can be applied to one or more optical surfaces are provided below with reference to FIGS. 3-4.

FIG. 3 illustrates a dielectric substrate 305 and a cured resin coating 310 adhered to the substrate. In some embodiments, the dielectric substrate 305 can be a film, a plate, a lens, optical or 3-dimension (3D) shaped resin components, other resin or resin components, and combinations thereof. In some embodiments, the dielectric substrate 305 can include polyethylene terephthalate (PET), polycarbonate (PC), polyethylene naphthalate (PEN), cyclic olefin polymer (COP), cyclic olefin copolymer (COC), acrylic, polyimide, aramid, glass, etc. In some embodiments, the dielectric substrate 305 can include silicon oxide, silicon nitride, aluminum oxide, niobium oxide, titanium oxide, zirconium oxide, hafnium oxide, tantalum oxide, magnesium fluoride, etc. In some embodiments, the dielectric substrate 305 can include a triacetyl cellulose film. Triacetyl cellulose (TAC) is a durable and easy to process thermoplastic exhibiting a high clarity and gloss that has exceptionally low haze, high moisture vapor transmission, and extremely low water permeability, but is relatively easy to cut. Triacetyl cellulose also shows good chemical resistance to organic and inorganic weak acids, hydrocarbons, and oils. The thickness of the dielectric substrate 305 is not particularly limited. For example, the dielectric substrate 305 can include a thickness from about 20 μm to about 200 μm. In some embodiments, the dielectric substrate 305 can include a thickness of about 500 nm or greater, such as about 750 nm or greater, about 1 μm or greater, about 10 μm or greater, about 20 μm or greater, about 50 μm or greater, about 100 μm or greater, about 200 μm or greater, or in ranges of about 500 nm to about 1 μm, about 1 μm to about 10 μm, about 10 μm to about 50 μm, about 50 μm to about 100 μm, about 100 μm to about 150 μm, about 150 μm to about 200 μm. In some embodiments, the dielectric substrate 305 can be subjected to a plasma and/or a chemical pretreatment prior to applying the cured resin coating 310 to improve adhesion properties.

The cured resin coating 310 can include a resin composition that can be formed by curing the resin coating 310 with ultraviolet (UV) light. The curing can be performed using well-known methods, as described in further detail below. The resin composition can include a monomer having a photo-polymerizable functional group. The monomer can include a molecular weight of about 205 or less. The molecular weight of the monomer and other components of the resin composition is a relative average molecular weight as calculated by Gel Permeation Chromatography. The monomer can include a photo-polymerizable functional group and can be miscible in water. In some embodiments, the photo-polymerizable function group of the monomer can be selected from the groups of acrylate, methacrylate, glycidyl, and thiol.

The resin composition can further include a siloxane oligomer including a dehydration-condensable functional group. The siloxane oligomer including a dehydration-condensable functional group can have a molecular weight between about 1,000 and about 20,000. The siloxane oligomer including a dehydration-condensable functional group and can be miscible in water. In some embodiments, the siloxane oligomer can be soluble in concentrations of 5 g or more per liter of water. In some embodiments, the dehydration-condensable functional group of the siloxane oligomer can be selected from the group of silanol, glycidyl, thiol, alkoxy cyanate, hydroxyl cyanate, and isocyanate.

The resin composition can also include a siloxane oligomer including a photo-polymerizable functional group and a dehydration-condensable functional group. The siloxane oligomer including a photo-polymerizable functional group and a dehydration-condensable functional group can have a molecular weight of about 1,000 or less. The molecular weight is a relative average molecular weight calculated by Gel Permeation Chromatography. The siloxane oligomer including a photo-polymerizable functional group and a dehydration-condensable functional group can be miscible in water. In some embodiments, the siloxane oligomer can be soluble in concentrations of 5 grams or more per liter of water. In some embodiments, the photo-polymerizable function group of the siloxane oligomer can be selected from the groups of acryloyl, methacrylate, glycidyl, isocyanate, and thiol. In some embodiments, the dehydration-condensable functional group of the siloxane oligomer can be selected from the group of silanol, glycidyl, thiol, alkoxy cyanate, hydroxyl cyanate, and isocyanate.

The resin composition can also include a metal oxide including a photo-polymerizable functional group and a dehydration-condensable functional group. The metal oxide can be selected from the group of zirconium oxide, silicon oxide, aluminum oxide, titanium oxide, cryolite (Na₃AlF₆), and magnesium fluoride. In some embodiments, the photo-polymerizable function group of the metal oxide can be selected from the groups of acrylate, methacrylate, glycidyl, and thiol. In some embodiments, the dehydration-condensable functional group of the metal oxide can be selected from the group of alkoxy cyanate, hydroxyl cyanate, and isocyanate.

In some embodiments, the resin composition includes a product of about 20 to about 40 parts by weight of the monomer including a photo-polymerizable functional group, about 10 to about 20 parts by weight of the siloxane oligomer including a photo-polymerizable functional group and a dehydration condensable functional group, about 10 to about 20 parts by weight of the siloxane oligomer including a dehydration condensable functional group and about 10 to about 50 parts by weight of the metal oxide including a photo-polymerizable functional group and a dehydration condensable functional group.

The resin composition can also include a photo-initiator. Generally, a photo-initiator includes a molecule that creates reactive species (e.g. free radicals, cations or anions) when exposed to UV radiation. The photo-initiator can include a photo-radical generator; and a photo-acid generator or a photo-base generator. A photo-radical generator generates a radical compound upon irradiation of light in the UV range. Photo-acid generators are chemical compounds which release, through decomposition, cationic species. Photo-acid generators generate an organic acid upon irradiation of light in the UV range. The generated organic acid accelerates a cationic UV curing of the resin composition. A photo-base generator is a compound that generates an organic base, such as amines, upon irradiation of light in the UV range. The generated organic base accelerates an anionic UV curing of the resin composition.

Examples of the photo-radical generator can include, but limited to, 1-hydroxycyclohexyl phenyl ketone, 2,2-dimethoxy-2-phenyl acetophenone, xanthone, fluorene, fluorenone, benzaldehyde, anthraquinone, triphenylamine, carbazole, 3-methyl-acetophenone, 4-chloro-benzophenone, 4,4′-dimethoxy benzophenone, 4,4′-diamino benzophenone, Mihira ketone, benzoyl propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethyl thioxanthone, 2-isopropyl thioxanthone, 2-chloro thioxanthone, 2-methyl-1-[4-(methylthio)phenyl]-2-morpholinopropan-1-one, 2,4,6-trimethylbenzoyl diphenylphosphine oxide, 2-benzyl-1-dimethylamino-1-(4-morpholinophenyl)butan-1-one, 1-[4-(2-hydroxyethoxy)-phenyl]-2-hydroxy-2-methylpropan-1-one, etc. In some embodiments, a combination of photo-radical generators can be used.

Examples of the photo-acid generator can include an onium salt and/or an organometallic salt, but are not limited thereto. For example, a diaryl iodonium salt, a triaryl sulfonium salt, an aryl diazonium salt, an iron-arene complex, or the like can be used. More specifically, examples of the photo-acid generators can include an aryl sulfonium hexafluoroantimonate salt, an aryl sulfonium hexafluorophosphate salt, a diphenyliodonium hexafluoroantimonate salt, a diphenyliodonium hexafluorophosphate salt, a ditolyliodonium hexafluorophosphate salt, a 9-(4-hydroxyethoxy phenyl)thianthrenium hexafluorophosphate salt. In some embodiments, a combination of photo-acid generators can be used.

Examples of appropriate photo-base generators can include, for example, chained tertiary amines, but are not limited thereto. For example, triethylamine, tri-n-propylamine, triisopropylamine, tri-n-butylamine, triisobutylamine, tri-n-pentylamine, triisopentylamine, N,N-diethylmethylamine, N,N-diisopropylmethylamine, N,N-diisopropylethylamine, N,N-di-n-butylmethylamine, N,N-diisobutylmethylamine, N,N-dimethyl-n-pentylamine, N,N-dimethylcyclopentylamine, N,N-dimethyl-n-hexylamine, N,N-dimethylcyclohexylamine, N,N-dimethylbenzylamine; for example, cyclic tertiary amines such as oxazole, thiazole, pyridine, N,N-dimethyl-4-aminopyridine, pyrazine, etc. In some embodiments, a combination of photo-acid generators can be used.

In some embodiments, the resin coating includes an organic component and an inorganic component. FIG. 4 illustrates a cross-section side view of a cured resin coating 410. In some embodiments, the organic component can include carbon and/or nitrogen. In some examples, the inorganic component can include at least one metal and/or metal oxide.

In some embodiments, the cured resin coating 410 includes a bottom portion 412. The bottom portion 412 can include a hydrophilic functional group. The cured resin coating 410 can self-separate upon being applied to a dielectric substrate. The hydrophilic functional group can form the bottom portion that can be configured to adhere to the substrate and exhibit hydrophilic properties. In some embodiments, the bottom portion 412 includes less than or equal to about 15 atomic percent (at. %) inorganic component and greater than or equal to about 85 at. % organic component. In some embodiments, the bottom portion 412 can include less than or equal to about 10 at. % inorganic component and greater than or equal to about 90 at. % organic component. The atomic percent can include the elemental ratio atomic percent as determined by Energy-dispersive X-ray spectroscopy (EDX) analysis.

In some embodiments, the cured resin coating 410 includes a surface portion 416. The surface portion 416 can be hydrophobic, and thus separate from the substrate. In some embodiments, the surface portion 416 includes greater than or equal to about 55 at. % inorganic component and less than or equal to about 35 at. % organic component. In some embodiments, the surface portion 416 can include greater than about 60 at. % inorganic component and greater than about 90 at. % organic component.

As stated above, a siloxane oligomer can include a photo-polymerizable functional group and a dehydration-condensable functional group. The photo-polymerizable functional group includes hydrophilic properties and can exhibit a strong adhesion to the organic substrate. The dehydration-condensable functional group can exhibit a strong adhesion to an inorganic metal oxide. The metal oxide can include hydrophobic properties, which causes the resin coating 410 to generally separate into the bottom portion 412, the surface portion 416, and an intermediate portion 414 there between within about 1 to about 30 seconds upon being applied to the dielectric substrate.

In some embodiments, the intermediate portion 414 can act as a hardness control layer. The intermediate portion 414 can include between about 5 at. % and about 65 at. % inorganic component and between about 35 at. % and about 95 at. % organic component. In some embodiments, the intermediate portion 414 can include between about 10 at. % and about 60 at. % inorganic component and between about 40 at. % and about 90 at. % organic component. In some embodiments, the cured resin coating 410 may include portions having a gradient of inorganic and organic portions. In some embodiments, the intermediate portion 414 can include sub-portions that can include between about 10 at. % and about 30 at. % inorganic component and between about 70 at. % and about 90 at. % organic component for a first sub-portion, about 30 at. % and about 40 at. % inorganic component and between about 60 at. % and about 70 at. % organic component for a second sub-portion, about 40 at. % and about 60 at. % inorganic component and between about 40 at. % and about 60 at. % organic component for a third sub-portion. In some embodiments, the intermediate portion 414 can include greater than three sub-portions. The siloxane frame can include a structure that exhibits stability when exposed to UV radiation and heat. In some embodiments, the siloxane frame provides a base for nano-printing.

The surface portion 416 can form a hydrophobic surface layer of the resin coating 410. The hydrophobic surface layer including surface portion 416 can be formed according to the contents listed in the following Table 1. In Table 1, the material refers to the composition of the inorganic component.

TABLE 1

| | Nanoparticle | Particle | | Resin coating | Zeta |
|---|---|---|---|---|---|
| Material | RI | size | | RI | potential |
| SiO₂ | 1.43 | 10-100 | nm | 1.46 | +1.5 mV |
| ZrO₂ | 2.00 | 7-50 | nm | 1.75 | +3.1 mV |
| TiO₂ | 2.20 | 20-50 | nm | 1.85 | +1.5 mV |
| Si/SiOₓ | 4.00 | 30-60 | nm | 2.75 | +5.5 mV |
| Hollow SiO₂ | 1.10-1.25 | 40-100 | nm | 1.30-1.38 | +1.1 mV |
| Cryolite | 1.33 | 50-80 | nm | 1.41 | +8.0 mV |
| MgF₂ | 1.38 | 60-120 | nm | 1.44 | +3.5 mV |

In some embodiments, the hydrophobic surface layer including surface portion 416 can include nanoparticles including a zeta potential from about +1 mV to about +8 mV. Zeta potential is the potential difference between the dispersion medium and the stationary layer of fluid attached to the dispersed particle. In other words, zeta potential is the potential difference between the dispersion medium and the stationary layer of fluid attached to the dispersed nanoparticle. Zeta potential is not measurable directly but it can be calculated using theoretical models. In some embodiments, the zeta potential can be measured according to the electrical potential between the nanoparticle and the surrounding fluid. For example, negative counter-ions can first attach to the positively charged particle. The ions can form a rigid layer around the particle. As the particle continues to attract more counter-ions, the negatively charged ions begin to be repelled by the other negative counter-ions as well as the rigid layer around the particle. An electrical potential can develop between the surface of the particle and the surrounding fluid. The electrical potential between the rigid layer of ions and the negatively ions being repelled is a zeta potential. In some embodiments, the higher the absolute value of the zeta potential, the more stable the dispersion of the particles. In aggregate, the zeta potential can be modified by changing the chemical environment (e.g. ionic strength of the nanoparticle and/or fluid) or by modifying the surface of the particles.

When a constant voltage is applied to the solution, the electrostatic force due to this voltage balances with the frictional force due to the viscosity of the solution. As a result, the zeta potential can be determined by the relationship established with the relative velocity of the motion of the solution and the contact phase. For example, the zeta potential can be calculated form the relative velocity of the motion of the solution and the contact phase based on the following equation 1.

$$ζ = \frac{η}{ϵ} \frac{υ}{V} \qquad ( 1 )$$

where “ζ” is the zeta potential and “υ” is the relative velocity of the motion of the solution and the contact phase. “V” is the voltage applied to the solution, “ε” is the dielectric constant of the solution, and “η” is the viscosity of the solution. From this relationship, the zeta potential can be measured by electro-osmosis or electrophoresis. Electrophoresis is a class of separation techniques in which chemical components separate by their ability to move through a conductive medium in response to an applied electric field. For example, an external electric field can be applied to the dielectric substrate such that the substrate is polarized. In the absence of other effects, the positively charged nanoparticles migrate away from the dielectric substrate's positively charged anode. The negatively charged components of the hydrophilic functional group migrate toward the positively charged dielectric, and any neutral components do not experience the electrical field and remain stationary. The charge can be stronger for some nanoparticles than others, and thus, a gradient of nanoparticles can develop, as shown in FIG. 4. Electroosmotic flow occurs because the dehydration-condensable functional group and the photo-polymerizable functional group apply a charge. For example, the silanol group (—SiOH) can ionize to form negatively charged silanate ions (—SiO—). Positively charged nanoparticles of the resin are attracted to the silanate ions. Some of these nanoparticles bind tightly to the silanate ions, forming a hard hydrophobic surface layer. Since the nanoparticles are solvated, the solution is also pulled along, producing the electroosmotic flow.

In some embodiments, the resin coating 410 can include a thickness range between about 1 μm to about 50 μm. However, other thicknesses of the coating can be utilized In some embodiments, the bottom portion 412 can include a thickness of about 500 nm or greater, such as about 750 nm or greater, about 1 μm or greater, or in ranges of about 500 nm to about 1 μm, about 1 μm to about 1.5 μm, about 1.5 μm to about 2 μm, about 1.25 μm to about 1.75 μm, about 1.75 μm to about 2 μm, or about 1 μm to about 1.75 μm, The intermediate portion 414 can includes a thickness between about 1 μm and 5 μm, however, other thicknesses of the layer can be utilized In some embodiments, the intermediate portion 414 can include a thickness of about 500 nm or greater, such as about 750 nm or greater, about 1 μm or greater, about 2 μm or greater, about 3μm or greater, about 4 μm or greater, about 5 μm or greater, or in ranges of about 500 nm to about 1 μm, about 1 μm to about 2 μm, about 2 μm to about 3 μm, about 3 μm to about 4 μm, about 4 μm to about 5 μm, about 2.5 μm to about 5 μm, and the surface portion 416 includes a thickness between about 1 μm and about 50 μm. However, other thicknesses of the layer can be utilized. In some embodiments, the surface portion 416 can include a thickness of about 1 μm or greater, such as about 10 μm or greater, about 20 μm or greater, about 30 μm or greater, about 40 μm or greater, about 50 μm or greater, or in ranges of about 1 μm to about 5 μm, about 1 μm to about 10 μm, about 10 μm to about 25 μm, about 25 μm to about 50 μm, about 30 μm to about 50 μm, about 40 μm to about 50 μm. Further, the portions of the cured resin coating 410 may not necessarily be strictly defined as some nanoparticles and/or elements of the hydrophilic functional group may not successfully migrate by electroosmotic flow. In some examples, an inorganic layer can also be deposited on the cured resin coating to improve optical function, mechanical function, and/or electromagnetic function of the optical device. Details regarding the deposition of an inorganic layer onto the cured resin coating are provided below with reference to FIG. 5.

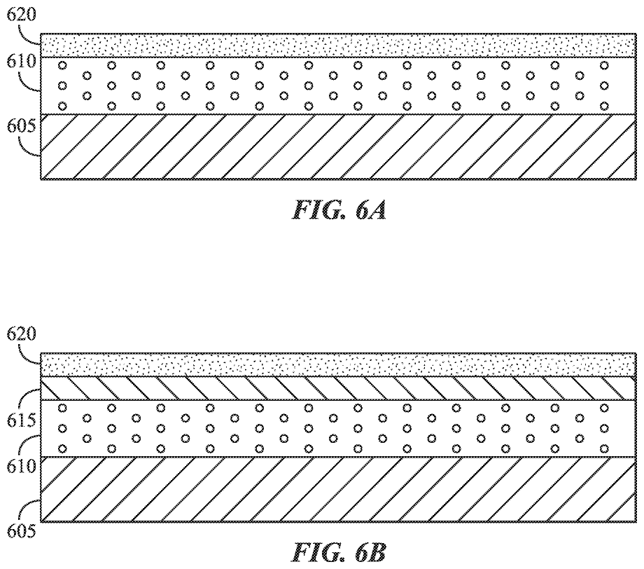

FIG. 5 illustrates a cross-section side view of a substrate 505, the cured resin coating 510, and an inorganic layer 515 disposed on the resin coating. The inorganic layer 515 can be a first inorganic layer, such that at least one inorganic layer can be disposed on the resin coating. The inorganic layer 515 can be included to improve optical function, mechanical function, and/or electromagnetic function. The inorganic layer 515 can include an interference coating, an anti-reflection coating, a mirror coating, a beam splitting coating, an index matching, or a combination thereof. The inorganic layer 515 can improve hardness of the substrate 505. In some embodiments, the inorganic layer 515 can be applied to improve conductivity and/or insulation properties. In some embodiments, the inorganic layer 515 can improve optical function as an inorganic interference coating. The inorganic layer 515 can be selected from the group of silicon oxide, silicon nitride, aluminum, aluminum oxide, niobium oxide, titanium oxide, zirconium oxide, hafnium oxide, tantalum oxide, magnesium fluoride, silver, gold, copper, and combinations thereof. In some embodiments, the inorganic layer 515 can be applied by vacuum coating and/or applying a solution, such as sol-gel coating, to deposit the inorganic layer 515 to the cured resin coating 510. In a vacuum coating, the inorganic layer 515 can be applied by at least one of a thermal evaporation, sputtering, chemical vapor deposition, and atomic layer deposition. In some embodiments, an anti-smudge layer can be used to avoid surface contamination and make the optical device easier to clean, as detailed below with reference to FIG. 6A.

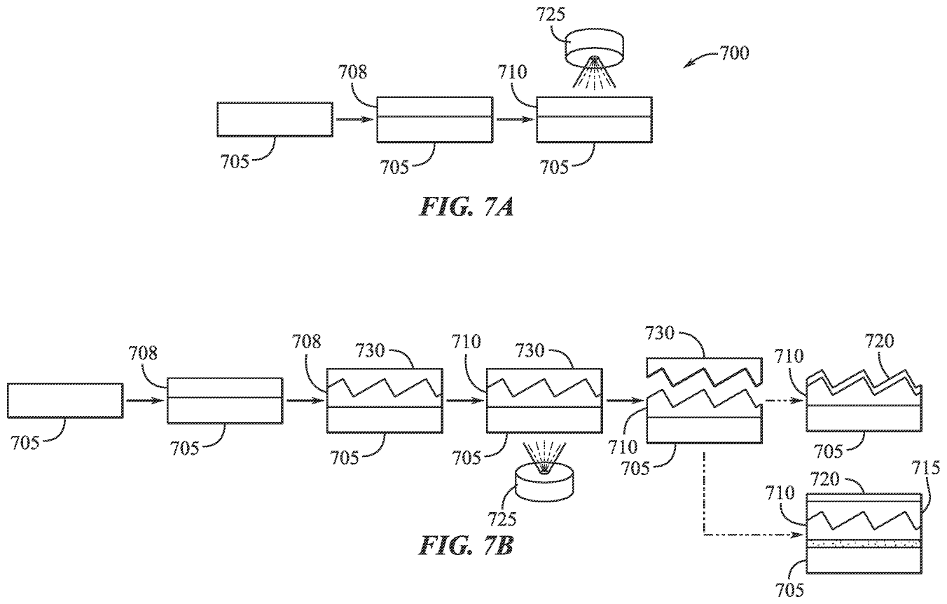

FIG. 6A illustrates a schematic cross section of a substrate 605, a resin coating 610, and an anti-smudge layer 620, according to an embodiment. In some embodiments, the anti-smudge layer 620 can include a fluorinated hydrocarbon. The anti-smudge layer 620 can be adhered to the surface of the resin coating and/or the inorganic layer. In some embodiments, the anti-smudge 620 layer repels water and/or oils to keep the surface of the optical device clean from residue. The anti-smudge layer 620 can provide low dynamic friction to the surface. The low friction of the fluorinated surface makes fingerprints easily removed by wiping, and can prevent contamination stains. In some embodiments, the anti-smudge layer 620 protects the surface of the optical device from scratches and preserves optical properties and texture. FIG. 6B illustrates a schematic cross section of a substrate 605, a resin coating 610 disposed on the resin coating, an inorganic layer 615, and an anti-smudge layer 620 disposed on the inorganic layer, according to an embodiment. In some embodiments the fluorinated hydrocarbon of the anti-smudge layer 620 can include linear chains or branched chains. In some embodiments, the linear chains can be rigid or flexible. Example methods for producing an optical device described above having a cured resin coating adhered to a dielectric substrate are provided below with reference to FIGS. 7A-7B.

FIG. 7A illustrates a method to prepare an optical device including a dielectric substrate 705 and a cured resin coating 710, according to an embodiment. In some embodiments, a viscous resin 708 can be applied to the dielectric substrate 705. In some embodiments, the resin 708 can include a viscosity of about 3000 cps (3 kg m⁻¹ s⁻¹) or less before curing. The viscosity can be measured with a Brookfield type viscometer (B Type viscometer), manufactured by Brookfield. In some embodiments, the viscous resin 708 can be dissolved in a solvent. In an embodiment where the resin is included in a solvent, the method to prepare an optical device including a dielectric substrate 705 and a cured resin coating 710 includes a solvent drying process after the resin 708 is applied to the dielectric substrate 705. In some embodiments, the dielectric substrate 705 can include a film and/or sheet substrate. The resin 708 can be applied to the dielectric substrate 705 by at least one of a slot dye coating, a comma coating, a wire bar coating, and a knife coating. In other embodiments, the dielectric substrate can include a sheet, a lens, an optical component, and/or can include 3D shapes. The resin 708 can be applied to the dielectric substrate 705 by at least one of a spin or a dip coating. In some embodiments, the resin 708 can be applied by lamination. In other words, the resin 708 can be applied onto another substrate and then transferred onto the dielectric substrate 705.

The resin 708 can be exposed to UV irradiation. In some embodiments, the UV curing can be conducted with any suitable UV light source 725. In some embodiments, the UV light source 725 can include a high pressure mercury lamp, a metal halide lamp, a non-electrode UV lamp, an LED light source including a wavelength peak at about 365 nm, between about 400 nm to about 365 nm, and/or between about 400 nm to about 430 nm. In some embodiments, the UV light source 725 can be exposed directly to the resin 708, which causes the resin to cure and form the cured resin coating 710. In some embodiments, the resin coating 710 can include a refractive index from about 1.25 to about 3.5. In some embodiments, the refractive index of the resin coating 710 may be from about 1.25 to about 1.5. In some embodiments, the refractive index may be in ranges of about 1.5 to about 2.5, about 2.5 to about 3.5, about 2 to about 3, about 1.5 to about 3.5, about 1.25 to about 3.25, or about 1.41 to about 1.85. In some embodiments, an inorganic layer and/or an anti-smudge layer can be included on the surface of the cured resin coating 710.

FIG. 7B illustrates another method to prepare an optical device 750 including dielectric substrate 705 and cured resin coating 710, according to an embodiment. In some embodiments, a viscous resin 708 can first be applied to the dielectric substrate 705. A mold 730 can then be coupled to the resin 708. The mold 730 can have a surface structure included. In some embodiments, the surface structure can include a configuration to provide an optical function and/or mechanical function to the cured resin coating 710. Non-limiting examples of optical functions can include refractive and/or reflective optical elements, micro lenses, lenticular lenses, diffractive optical elements, photonic materials, metal materials, scattering materials, anti-glare, etc. Lenses can be flat, convex, concave and/or combinations thereof. In some embodiments, the resin surface shape can be spherical or aspherical. Non-limiting examples of mechanical functions provided by the surface structure can include a matte surface, haptics, surface wettability variations and control, surface contact angle variations, improved ability to grip by adding a rough or a smooth texture, etc. In some embodiments, the surface structure can be included by embossing. In other embodiments, the surface structure can be included by nano-imprinting or phase separation of nanoparticles.

In some embodiments, the mold 730 can be coupled to the resin 708 while the resin 708 is cured by UV irradiation. The UV curing can be conducted with any suitable UV light source 725. In some embodiments, the UV light source 725 can be applied to the dielectric substrate 705. The UV light can travel through the substrate 705 to form the cured resin coating 710. After the resin 708 is cured, the cured resin 710 can be released from the mold 730. In some embodiments, an anti-smudge layer 720 can then be applied to the cured resin coating 710. In other embodiments, an inorganic layer 715 can be applied to the cured resin coating 710. In other embodiments, an inorganic layer 715 can be applied to the cured resin coating 710 and then the anti-smudge layer 720 can be applied to the inorganic layer 715. As indicated in Table 1, in some embodiments, the resin coating 710 can include a refractive index from about 1.25 to about 3.5.

### Test Methodologies

The following test methodologies were used to evaluate the adhesion/release properties of the compositions of the Examples:

Cross-hatch adhesion Test (protocol of ASTM D3359 Method B).

A crosshatch pattern was made through the resin coating film to the substrate with a sharp blade. Detached flakes of coating were removed by brushing with a soft brush. A pressure-sensitive tape was applied over the crosshatch cut. The tape was smoothed into place using a pencil eraser over the area of the incisions. Tape was removed by pulling it off rapidly back over itself as close to an angle of 180° as possible. Adhesion can be assessed on a 0 to 5 scale. (0—Greater than 65% area removed and 5 indicates 0% area removed)

### Simulated Solar Radiation Accelerated Weathering Test

An Atlas Ci4000 Weather-Ometer R was used for conducting the simulated radiation accelerated weathering, i.e., fatigue. The samples were exposed to UV light for 150 hours using a borosilicate filtered Xenon arc lamp with an output of 2 Watts per square meter at 420 nm. The temperature in the Atlas Ci4000 Weather-Ometer R was maintained at 63° C. and the relative humidity was controlled at 70% humidity. The temperature of the black panel, which has a thermometer connected to it and is representative of the test samples, was maintained at 89° C. The resin coating was subjected to a rubbing 350 cycle at the center of the resin coating film.

### Wipe Test

The samples were exposed to UV light for 150 hours using a borosilicate filtered Xenon arc lamp with an output of 2 Watts per square meter at 420 nm. The resin coating was subjected to a rubbing 350 cycle at the center of the resin coating film. A visual inspection was conducted after the UV exposure. DI water was dripped on the surface and held for 60 seconds. A second visual inspection was conducted. Light pressure was applied along an edge of the sample with Scott© C-fold paper towels and a third visual inspection was conducted. A new towel was used before every test cycle. The paper towel was cut into about 1.2 to 1.5 cm wide strips and folded in half. The paper towel was then wrapped over the wipe head with the length of the strip running parallel to the direction of travel. Appropriate weight was placed on the stem to achieve the desired force. About 0.25 mL of solution was placed onto the sample area prior to initiating the test. Damage to the area was captured utilizing image processing software to determine damage area in mm² and then the area was normalized. The normalized area in percentage (%) was the damaged area divided by the total wipe area.

The test area was 2000 mm² (50 mm by 40 mm). Deionized water was applied to the test area. A rubbing condition was applied with 500 gf at 60 cycles/min wiping speed, 25 mm stroke length, and a total of 1000 cycles. A visual inspection was conducted, and DI water was reapplied. A rubbing condition was applied with 3250 gf at 60 cycles/min wiping speed, 25 mm stroke length, and a total of 350 cycles. A visual inspection was conducted and Oreic acid was applied. A rubbing condition was applied with 3250 gf at 60 cycles/min wiping speed, 25 mm stroke length, and a total of 350 cycles. A visual inspection and abrasion/release peeling area % was determined with the following examples.

### EXAMPLES

A Simulated Solar Radiation Accelerated Weathering abrasion test, as described above, was conducted for a resin composition including a monomer including a photo-polymerizable functional group a siloxane oligomer including a photo-polymerizable functional group and a dehydration-condensable functional group, a siloxane oligomer including a dehydration-condensable functional group, and a metal oxide including a photo-polymerizable functional group and a dehydration-condensable functional group. The monomer was characterized by being miscible with water. In the examples, the monomer is soluble in 5 g or more per liter of water and has a molecular weight less than 205. The molecular weight of the components is a relative average molecular weight calculated by gel permeation chromatography. The one or more photo-polymerizable functional groups include glycidyl methacrylate, 2-Hydroxy ethyl acrylate, and acryoll morpholine. The siloxane oligomer photo-polymerizable functional group includes an acryl, epoxy, thiol, isocyanate, or oxetane group and the siloxane oligomer dehydration-condensable functional group includes a methoxy or ethoxy group. The metal oxide includes nanoparticles including silicon, silicon oxide, silicon dioxide, zirconium oxide, titanium oxide, iron oxide, nickel oxide, tin oxide, indium oxide, and aluminum oxide.

The thickness of the resin compositions were between about 3 μm to about 50 μm. The mass percentage of the monomer was between about 20% to about 40%. The mass % of the siloxane oligomer was between about 0% to about 45% for the siloxane oligomer including the photo-polymerizable functional group and dehydration-condensable functional group (siloxane oligomer B) and about 0% to about 45% for the siloxane oligomer including only the dehydration-condensable functional group (siloxane oligomer C). The mass percentage of the metal oxide including nanoparticles was between about 5% to about 50%.

### Example 1

A resin composition including 20% mass of monomer, 30% mass of siloxane oligomer B, 30% mass of siloxane oligomer C, and 20% mass of metal oxide was subjected to a Simulated Solar Radiation Accelerated Weathering abrasion test described above. The resin composition exhibited a 0% area peel off.

### Example 2

A resin composition including 40% mass of monomer, 25% mass of siloxane oligomer B, 25% mass of siloxane oligomer C, and 10% mass of metal oxide was subjected to a Simulated Solar Radiation Accelerated Weathering abrasion test described above. The resin composition exhibited a 0% area peel off.

### Example 3

A resin composition including 30% mass of monomer, 20% mass of siloxane oligomer B, 20% mass of siloxane oligomer C, and 30% mass of metal oxide was subjected to a Simulated Solar Radiation Accelerated Weathering abrasion test described above. The resin composition exhibited a 0% area peel off.

### Example 4

A resin composition including 50% mass of monomer, 45% mass of siloxane oligomer B, 0% mass of siloxane oligomer C, and 5% mass of metal oxide was subjected to a Simulated Solar Radiation Accelerated Weathering abrasion test described above. The resin composition exhibited over 20% area peel off.

### Example 5

A resin composition including 50% mass of monomer, 0% mass of siloxane oligomer B, 45% mass of siloxane oligomer C, and 5% mass of metal oxide was subjected to a Simulated Solar Radiation Accelerated Weathering abrasion test described above. The resin composition exhibited over 10% area peel off.

### Example 6

A resin composition including 40% mass of monomer, 5% mass of siloxane oligomer B, 5% mass of siloxane oligomer C, and 50% mass of metal oxide was subjected to a Simulated Solar Radiation Accelerated Weathering abrasion test described above. The resin composition exhibited over 30% area peel off.

To the extent applicable to the present technology, gathering and use of data available from various sources can be used to improve the delivery to users of invitational content or any other content that can be of interest to them. The present disclosure contemplates that in some instances, this gathered data can include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data can be used to provide insights into a user's general wellness, or can be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user can be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. An optical device, comprising:
a dielectric substrate; and
a cured resin coating adhered to the substrate, wherein the cured resin coating comprises:
an organic component and an inorganic component distributed to form a surface portion, an intermediate portion, and a bottom portion, wherein:
the surface portion includes greater than about 60 at. % inorganic component and less than about 40 at. % organic component;
the intermediate portion includes between about 10 at. % and about 60 at % inorganic component and between about 40 at. % and about 90 at. % inorganic component; and
the bottom portion includes less than about 10 at. % inorganic component and greater than about 90 at. % organic component.

2. The optical device of claim 1, wherein the cured resin coating comprises a thickness between about 1 μm and about 50 μm.

3. The optical device of claim 1, wherein the inorganic component comprises a material having a Zeta potential from about +1 mV to about +8 mV.

4. The optical device of claim 1, further comprising an inorganic layer disposed on the cured resin coating.

5. The optical device of claim 4, wherein the inorganic layer comprises at least one of silicon oxide, silicon nitride, aluminum, aluminum oxide, niobium oxide, titanium oxide, zirconium oxide, hafnium oxide, tantalum oxide, magnesium fluoride, silver, gold, copper, and combinations thereof.

6. The optical device of claim 1, further comprising an anti-smudge layer including a fluorinated hydrocarbon.

7. The optical device of claim 1, wherein the substrate is selected from the group of a triacetylcellulose film, a lens, a 3D-shaped resin component, and combinations thereof.

8. The optical device of claim 1, wherein the cured resin coating comprises a refractive index from about 1.25 to about 3.5.

9. The optical device of claim 1, wherein the cured resin coating comprises a surface structure including at least one of a refractive optical element, a reflective optical element, a diffractive optical element, an anti-glare surface, or a micro lens.

10. The optical device of claim 1, wherein the cured resin coating is UV cured.

11. A resin coating, comprising:
a hydrophilic adhesion layer;
a hardness control layer; and
a hydrophobic surface layer.

12. The resin coating of claim 11, wherein the resin coating comprises a viscosity of 3,000 cps or less (3 kg m⁻¹ s⁻¹) before curing.

13. The resin coating of claim 11, wherein the hydrophobic surface layer comprises a nanoparticle having a Zeta potential from about +1 mV to about +8 mV.

14. A resin, comprising:
a monomer including a first photo-polymerizable functional group;
a first siloxane oligomer including a second photo-polymerizable functional group and a first dehydration-condensable functional group;
a second siloxane oligomer including a second dehydration-condensable functional group;
a metal oxide including a third photo-polymerizable functional group and a third dehydration-condensable functional group; and
a photoinitiator.

15. The resin of claim 14, further comprising:
about 20 to about 40 parts by weight of the monomer;
about 10 to about 20 parts by weight of the first siloxane oligomer;
about 10 to about 20 parts by weight of the second siloxane oligomer; and
about 10 to about 50 parts by weight of the metal oxide.

16. The resin of claim 14, wherein:
the monomer comprises a molecular weight of about 205 or less;
the first siloxane oligomer comprises a molecular weight of about 1,000 or less; and
the second siloxane oligomer comprises a molecular weight between about 1,000 and about 20,000.

17. The resin of claim 14, wherein the first photo-polymerizable functional group is selected from the group of acrylate, methacrylate, glycidyl, and thiol;
the second photo-polymerizable functional group is selected from the group of acrylate, methacrylate, glycidyl, and thiol; and
the third photo-polymerizable functional group is selected from the group of acrylate, methacrylate, glycidyl, and thiol.

18. The resin composition of claim 14, wherein:
the first dehydrationcondensable group is selected from the group of alkoxy cyanate, hydroxyl cyanate, and isocyanate; and
the second dehydration-condensable group is selected from the group of alkoxy cyanate, hydroxyl cyanate, and isocyanate.

19. The resin composition of claim 14, wherein the metal oxide is selected from the group of zirconium oxide, silicon oxide, iron oxide, nickel oxide, indium oxide, tin oxide, aluminum oxide, titanium oxide, cryolite (Na₃AlF₆), and magnesium fluoride.

20. The resin composition of claim 14, wherein the photo initiator comprises:
a photo-radical generator; and
a photo-acid generator or a photo-base generator.
